(19) United States
(12) Patent Application Publication
(10) Pub. No.: US 2026/0361794 A1
(43) Pub. Date: Nov. 12, 2026

(54) ADAPTIVE KEEP ALIVE TIMEOUT FOR DATA STORAGE SYSTEMS

(71) Applicant: Western Digital Technologies, Inc., San Jose, CA (US)

(72) Inventors: Swarup Kulkarni, Bangalore (IN); Rakesh Singh, Bangalore (IN)

(21) Appl. No.: 19/199,494

(22) Filed: May 6, 2025

(51) Int. Cl. H04L 67/145; H04L 41/0604; H04L 67/1097

(52) U.S. Cl. CPC H04L 67/145; H04L 41/0627; H04L 67/1097

(57) ABSTRACT

Systems, methods, and storage interface controllers for adaptive keep alive timeout (KATO) in a data storage systems are described. The storage interface controllers, such as Non-Volatile Memory Express over Fabric (NVMeoF) adapters, determine default timeout values for different timeout status codes and store them in a timeout data structure. In response to determining a timeout condition for a connected host system, the storage interface controller determines a timeout status code for the timeout condition and sends a timeout notification with the timeout status code to the host system. The host system may respond to the timeout notification by using the timeout status code to adjust the retry pattern used in response to the timeout condition.

### TECHNICAL FIELD

The present disclosure generally relates to storage systems supporting a plurality of hosts and, more particularly, to using storage interface controllers, such as Non-Volatile Memory Express (NVMe) adapters, to manage keep alive timeouts (KATOs) for improved allocation and use of host connections.

### BACKGROUND

Non-volatile memory express (NVMe) over Fabrics (NVMeoF) storage systems have become increasingly prevalent in modern data centers. These systems allow for disaggregated storage architectures where NVMe drives are shared over a network, enabling flexible and scalable storage solutions. In such environments, maintaining reliable connections between host systems, storage controllers, and back end data storage devices is crucial for system performance and data integrity.

Keep alive timeout (KATO) mechanisms are commonly used in NVMeoF systems to detect the status of connections between hosts and controllers. However, managing KATO in large-scale deployments with numerous hosts and storage devices can present challenges. Fixed timeout values may not adequately address varying network conditions, device states, or system configurations. Additionally, inefficient handling of timeout conditions can lead to unnecessary network traffic, increased latency, and potential disruptions in storage access.

Therefore, there still exists a need for storage systems with adaptive keep alive timeout mechanisms that can dynamically adjust to varying network conditions, device states, and system configurations in large-scale NVMeoF deployments.

### SUMMARY

Various aspects for adaptive keep-alive timeout (KATO) handling using storage interface controllers, such as the storage interface adapters in the enclosure of an NVMeoF system, in data storage systems are described. More particularly, storage interface controllers may use monitoring of system status in response to timeout events to provide a timeout status code and adaptive timeout values for adjusting host retry patterns.

One general aspect includes a storage system that includes a first storage interface controller including: a host interface configured to receive host storage commands from at least one host system; at least one memory; and at least one processor. The at least one processor is configured to, alone or in combination: determine, for each timeout status code of a plurality of timeout status codes, a corresponding default timeout value for that timeout status code, where each timeout status code corresponds to a different system status; determine a timeout condition for communication from the at least one host system; determine, for the timeout condition, a current timeout status code from the plurality of timeout status codes; and send, to the at least one host system, a timeout notification may include the current timeout status code, where the at least one host system is configured to adjust, responsive to the current timeout status code, a retry pattern for communication from the at least one host system to the first storage interface controller.

Implementations may include one or more of the following features. The at least one processor may be further configured to, alone or in combination: determine, for the timeout condition, a reconnection time based on a restoration of communication from the at least one host system; modify, based on the reconnection time, the default timeout value for the current timeout status code to an updated timeout value; and use the updated timeout value for future timeout conditions having a same timeout status code as the current timeout status code. The first storage interface controller may further include a timeout data structure comprising an entry for each timeout status code of the plurality of timeout status codes; each entry may include that timeout status code and a corresponding timeout value; and the at least one processor may be further configured to, alone or in combination, store, for each timeout status code and at a first time, the corresponding default timeout value as the corresponding timeout value. The at least one processor may be further configured to, alone or in combination: determine, responsive to a reconnection following a timeout condition for a timeout status code, an updated timeout value for that timeout status code; and store, at a second time, the updated timeout value for that timeout status code in the corresponding entry for that timeout status code in the timeout data structure. The at least one processor may be further configured to, alone or in combination: determine, at a third time, a change in configuration of the storage system; and reset, responsive to the change in configuration, the entries for the plurality of timeout status codes to the corresponding default timeout values. The at least one processor may be further configured to, alone or in combination, send the timeout data structure to the at least one host system. The at least one host system may be further configured to, responsive to the current timeout status code in the timeout notification, determine the corresponding timeout value from the timeout data structure, and the adjusted retry pattern may be: based on the corresponding timeout value; delay at least one communication retry; and change a connection termination time for the retry pattern from a default connection termination time. The at least one host system may be further configured to, responsive to receiving the timeout notification, send a feature request to the first storage interface controller, and the at least one processor may be further configured to, alone or in combination, send the timeout data structure to the at least one host system responsive to receiving the feature request. The at least one host system may include a first host system and at least one other host system, and the first host system may be configured to: receive the timeout notification from the first storage interface controller; and send, responsive to receiving the timeout notification, the timeout notification to the at least one other host system. The at least one other host system may be configured to: receive the timeout notification from the first host system; determine, based on the current timeout status code, whether the timeout condition applies to at least one connection to the first storage interface controller from the at least one other host system; and adjust, responsive to the timeout condition applying to the at least one connection to the first storage interface controller, a retry pattern for communication from the at least one other host system to the first storage interface controller. The storage system may further include a second storage interface controller comprising a second host interface configured to receive host storage commands from the at least one host system. The at least one processor may be further configured to, alone or in combination: determine, based on the timeout condition, that the host interface to the at least one host system is inoperable; and send the timeout notification to the second storage interface controller. The second storage interface controller may be configured to forward the timeout notification to the at least one host system using the second host interface. The storage system may further include a data storage device enclosure comprising a plurality of data storage devices and the first storage interface controller. The first storage interface controller may further include a storage interface configured for communication with the plurality of data storage devices, and the at least one processor may be further configured to, alone or in combination: establish host connections between the at least on host system and the plurality of data storage devices; and direct received host storage commands to target data storage devices from the plurality of data storage devices based on the host connections. The plurality of timeout status codes may include timeout status codes corresponding to different system status selected from: data storage device replacement; data storage device hot plug transition; storage interface link down; host interface network malfunction; and controller reset.

Another general aspect includes a computer-implemented method that includes: receiving, by a first storage interface controller, host storage commands from at least one host system; determining, by the first storage interface controller and for each timeout status code of a plurality of timeout status codes, a corresponding default timeout value for that timeout status code, where each timeout status code corresponds to a different system status; determining, by the first storage interface controller, a timeout condition for communication from the at least one host system; determining, by the first storage interface controller and for the timeout condition, a current timeout status code from the plurality of timeout status codes; sending, by the first storage interface controller and to the at least one host system, a timeout notification comprising the current timeout status code; and adjusting, by the at least one host system and responsive to the current timeout status code in the timeout notification, a retry pattern for communication from the at least one host system to the first storage interface controller.

Implementations may include one or more of the following features. The computer-implemented method may further include: determining, by the first storage interface controller and for the timeout condition, a reconnection time based on a restoration of communication from the at least one host system; modifying, by the first storage interface controller and based on the reconnection time, the default timeout value for the current timeout status code to an updated timeout value; and using, by the first storage interface controller, the updated timeout value for future timeout conditions having a same timeout status code as the current timeout status code. The computer-implemented method may further include storing, by the first storage interface controller, a timeout data structure comprising an entry for each timeout status code of the plurality of timeout status codes, where: each entry may include that timeout status code and a corresponding timeout value; and the corresponding timeout value, at a first time, is the corresponding default timeout value. The computer-implemented method may further include: determining, by the first storage interface controller and responsive to a reconnection following a timeout condition for a timeout status code, an updated timeout value for that timeout status code; and storing, by the first storage interface controller and at a second time, the updated timeout value for that timeout status code in the corresponding entry for that timeout status code in the timeout data structure. The computer-implemented method may further include: determining, by the first storage interface controller and at a third time, a change in configuration of a storage system; and resetting, by the first storage interface controller and responsive to the change in configuration, the entries for the plurality of timeout status codes to the corresponding default timeout values The computer-implemented method may further include: sending, by the first storage interface controller, the timeout data structure to the at least one host system; determining, by the at least one host system and responsive to the current timeout status code in the timeout notification, the corresponding timeout value from the timeout data structure; delaying, by the at least one host system and based on the corresponding timeout value, at least one communication retry in the retry pattern; and changing, by the at least one host system and based on the corresponding timeout value, a connection termination time for the retry pattern from a default connection termination time. The computer-implemented method may further include: sending, by the at least one host system and responsive to receiving the timeout notification, a feature request to the first storage interface controller; and sending, by the first storage interface controller and responsive to the feature request, the timeout data structure to the at least one host system. The computer-implemented method may further include: receiving, by a first host system of the at least one host system, the timeout notification from the first storage interface controller; sending, by the first host system and responsive to receiving the timeout notification, the timeout notification to at least one other host system of the at least one host system; receiving, by the at least one other host system, the timeout notification from the first host system; determining, by the at least one other host system and based on the current timeout status code, whether the timeout condition applies to at least one connection to the first storage interface controller from the at least one other host system; and adjusting, by the at least one other host system and responsive to the timeout condition applying to the at least one connection to the first storage interface controller, a retry pattern for communication from the at least one other host system to the first storage interface controller. The computer-implemented method may further include: determining, by the first storage interface controller and based on the timeout condition, that a host interface to the at least one host system is inoperable; sending, by the first storage interface controller, the timeout notification to a second storage interface controller may include a second host interface configured to receive host storage commands from the at least one host system; and forwarding, by the second storage interface controller, the timeout notification to the at least one host system using the second host interface.

Still another general aspect includes a storage system that includes: a plurality of data storage devices; a host interface configured to receive host storage commands from a plurality of host systems; a storage device interface configured to direct host storage commands to the plurality of data storage devices; means for determining, for each timeout status code of a plurality of timeout status codes, a corresponding default timeout value for that timeout status code, where each timeout status code corresponds to a different system status; means for determining a timeout condition for communication from at least one host system of the plurality of host systems; means for determining, for the timeout condition, a current timeout status code from the plurality of timeout status codes; and means for sending, to the at least one host system, a timeout notification comprising the current timeout status code, where the at least one host system is configured to adjust, responsive to the current timeout status code, a retry pattern for communication from the at least one host system to at least one data storage device of the plurality of data storage devices.

The various embodiments advantageously apply the teachings of data storage devices and/or multi-device storage systems to improve the functionality of such computer systems. The various embodiments include operations to overcome or at least reduce the issues previously encountered in storage arrays and/or systems and, accordingly, are more reliable, efficient, and/or secure than other computing systems. That is, the various embodiments disclosed herein include hardware and/or software with functionality to improve KATO notifications to and handing by host systems, such as by providing timeout status codes and adaptive timeout values to hosts for adjusting retry patterns. Accordingly, the embodiments disclosed herein provide various improvements to storage networks and/or storage systems.

It should be understood that language used in the present disclosure has been principally selected for readability and instructional purposes, and not to limit the scope of the subject matter disclosed herein.

### BRIEF DESCRIPTION OF THE DRAWINGS

FIG. 1 schematically illustrates a multi-device storage system supporting a plurality of host systems.

FIG. 2 is a flowchart of an example method of using the storage controller of FIG. 1 to provide adaptive KATO logic.

FIG. 3 is a flowchart of an example method of the response of the host systems of FIG. 1 to the adaptive KATO notifications.

FIG. 4 schematically illustrates a host node of the multi-device storage system of FIG. 1.

FIG. 5 schematically illustrates some elements of the storage controller of FIG. 1 in more detail.

FIG. 6 is a flowchart an example method of using timeout status codes to adjust retry patterns.

FIGS. 7a and 7b are a flowchart of an example method of using a timeout data structure to manage timeout status codes and adaptive timeout values.

FIG. 8 is a flowchart of an example method of using a timeout data structure to respond to timeout notifications.

FIGS. 9a and 9b are flowcharts of example methods of sharing timeout notifications in a data storage system.

### DETAILED DESCRIPTION

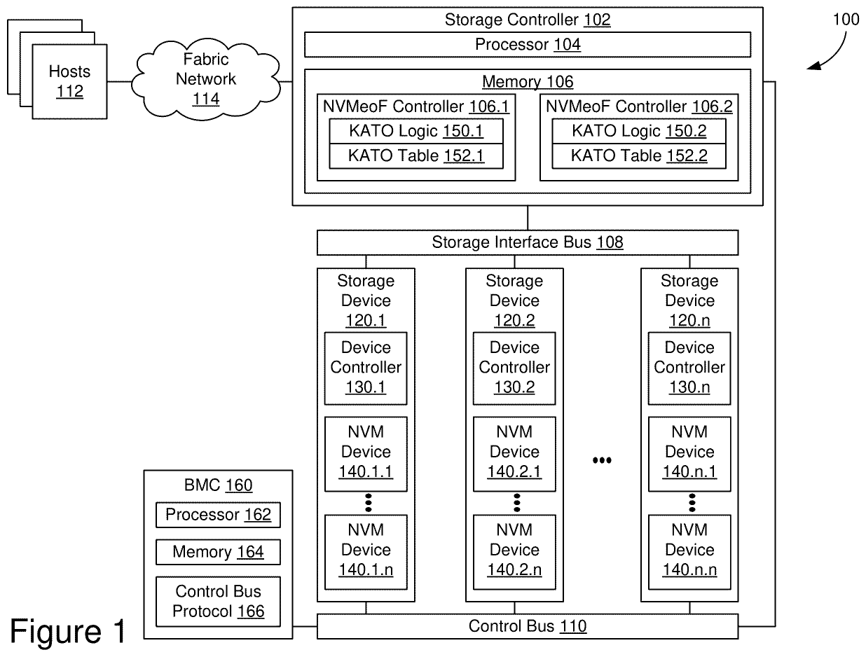

FIG. 1 shows an embodiment of an example data storage system 100 with multiple data storage devices 120 supporting a plurality of host systems 112 through storage controller 102. While some example features are illustrated, various other features have not been illustrated for the sake of brevity and so as not to obscure pertinent aspects of the example embodiments disclosed herein. To that end, as a non-limiting example, data storage system 100 may include one or more data storage devices 120 (also sometimes called information storage devices, storage devices, disk drives, or drives) configured in a storage node with storage controller 102. In some configurations, storage controller 102 may be embodied in one or more storage interface adapters or controllers and associated switches in a storage enclosure with associated data storage devices 120. In some embodiments, storage devices 120 may be configured in a server, storage array blade, all flash array appliance, just-a-bunch-of-flash (JBOF) enclosure, or similar storage unit for use in data center storage racks or chassis. Storage devices 120 may interface with one or more host nodes or host systems 112 and provide data storage and retrieval capabilities for or through those host systems. In some embodiments, storage devices 120 may be configured in a storage hierarchy that includes storage nodes, storage controllers (such as storage controller 102), and/or other intermediate components between storage devices 120 and host systems 112. For example, each storage controller 102 may be responsible for a corresponding set of storage devices 120 in a storage node and their respective storage devices may be connected through a corresponding backplane network or internal bus architecture including storage interface bus 108 and/or control bus 110, though only one instance of storage controller 102 and corresponding storage node components are shown. In some embodiments, storage controller 102 may include or be configured within a host bus adapter for connecting storage devices 120 to fabric network 114 for communication with host systems 112.

In the embodiment shown, a number of storage devices 120 are attached to a common storage interface bus 108 for host communication through storage controller 102. For example, storage devices 120 may include a number of drives arranged in a storage array, such as storage devices sharing a common rack, unit, or blade in a data center or the solid state drives (SSDs) in an all flash array. In some embodiments, storage devices 120 may share a backplane network, network switch(es), and/or other hardware and software components accessed through storage interface bus 108 and/or control bus 110. For example, storage devices 120 may connect to storage interface bus 108 and/or control bus 110 through a plurality of physical port connections that define physical, transport, and other logical channels for establishing communication with the different components and subcomponents for establishing a communication channel to host 112. In some embodiments, storage interface bus 108 may provide the primary host interface for storage device management and host data transfer, and control bus 110 may include limited connectivity to the host for low-level control functions.

In some embodiments, storage devices 120 may be referred to as a peer group or peer storage devices because they are interconnected through storage interface bus 108 and/or control bus 110. In some embodiments, storage devices 120 may be configured for peer communication among storage devices 120 through storage interface bus 108, with or without the assistance of storage controller 102 and/or host systems 112. For example, storage devices 120 may be configured for direct memory access using one or more protocols, such as non-volatile memory express (NVMe), remote direct memory access (RDMA), NVMe over fabric (NVMeOF), etc., to provide command messaging and data transfer between storage devices using the high-bandwidth storage interface and storage interface bus 108.

In some embodiments, data storage devices 120 are, or include, solid-state drives (SSDs). Each data storage device 120.1-120.n may include a non-volatile memory (NVM) or device controller 130 based on compute resources (processors and memory) and a plurality of NVM or media devices 140 to provide a non-volatile storage medium for data storage (e.g., one or more NVM device(s), such as one or more flash memory devices). In some embodiments, a respective data storage device 120 of the one or more data storage devices includes one or more NVM controllers, such as flash controllers or channel controllers (e.g., for storage devices having NVM devices in multiple memory channels). In some embodiments, data storage devices 120 may each be packaged in a housing, such as a multi-part sealed housing with a defined form factor and ports and/or connectors for interconnecting with storage interface bus 108 and/or control bus 110. Each data storage device may include or have associated with it a unique data storage device identifier (device ID) used by storage controller 102 and/or other system components to manage or interface with individual data storage devices.

In some embodiments, a respective data storage device 120 may include a single medium device while in other embodiments the respective data storage device 120 includes a plurality of media devices. In some embodiments, media devices include NAND-type flash memory or NOR-type flash memory. In some embodiments, data storage device 120 may include one or more hard disk drives (HDDs). In some embodiments, data storage devices 120 may include a flash memory device, which in turn includes one or more flash memory die, one or more flash memory packages, one or more flash memory channels or the like. However, in some embodiments, one or more of the data storage devices 120 may have other types of non-volatile data storage media (e.g., phase-change random access memory (PCRAM), resistive random access memory (ReRAM), spin-transfer torque random access memory (STT-RAM), magneto-resistive random access memory (MRAM), etc.).

In some embodiments, each storage device 120 includes a device controller 130, which includes one or more processing units (also sometimes called central processing units (CPUs), processors, microprocessors, or microcontrollers) configured to execute instructions in one or more programs. In some embodiments, the one or more processors are shared by one or more components within, and in some cases, beyond the function of the device controllers. In some embodiments, device controllers 130 may include firmware for controlling data written to and read from media devices 140, one or more storage (or host) interface protocols for communication with other components, as well as various internal functions, such as garbage collection, wear leveling, media scans, and other memory and data maintenance. For example, device controllers 130 may include firmware for running the NVM layer of an NVMe storage protocol alongside media device interface and management functions specific to the storage device. Media devices 140 may be coupled to device controllers 130 through connections that typically convey commands in addition to data, and optionally convey metadata, error correction information and/or other information in addition to data values to be stored in media devices and data values read from media devices 140. Media devices 140 may include any number (i.e., one or more) of memory devices including, without limitation, non-volatile semiconductor memory devices, such as flash memory device(s).

In some embodiments, media devices 140 in storage devices 120 are divided into a number of addressable and individually selectable blocks, sometimes called erase blocks. In some embodiments, individually selectable blocks are the minimum size erasable units in a flash memory device. In other words, each block contains the minimum number of memory cells that can be erased simultaneously (i.e., in a single erase operation). Each block is usually further divided into a plurality of pages and/or word lines, where each page or word line is typically an instance of the smallest individually accessible (readable) portion in a block. In some embodiments (e.g., using some types of flash memory), the smallest individually accessible unit of a data set, however, is a sector or codeword, which is a subunit of a page. That is, a block includes a plurality of pages, each page contains a plurality of sectors or codewords, and each sector or codeword is the minimum unit of data for reading data from the flash memory device.

A data unit may describe any size allocation of data, such as host block, data object, sector, page, multi-plane page, erase/programming block, media device/package, etc. In some configurations, the data unit may be the value portion of a key-value pair, where hosts 112 may define a key and provide a corresponding data unit of unstructured data (from a storage device perspective) having a memory size selected by the host. Storage devices 120 may store the key as a unique index value and map storage locations meeting the memory size in NVM devices 140 for storing the data unit. Storage locations may include physical and/or logical locations on storage devices 120 and may be described and/or allocated at different levels of granularity depending on the storage medium, storage device/system configuration, and/or context. For example, the storage device may manage the variable sizes of key-value pairs by allocating appropriately sized storage locations mapped to the particular key for addressability for host read/write purposes but managed as pages within storage device addressing managed in the media flash translation layer (FTL) in other contexts. Media segments may include physical storage locations on storage devices 120, which may also correspond to one or more logical storage locations. In some embodiments, media segments may include a continuous series of physical storage locations, such as adjacent data units on a storage medium, and, for flash memory devices, may correspond to one or more media erase or programming blocks.

In some embodiments, storage controller 102 may be coupled to data storage devices 120 through a network interface that is part of host fabric network 114 and includes storage interface bus 108 as a host fabric interface. In some embodiments, host systems 112 are coupled to data storage system 100 through fabric network 114 and storage controller 102 may include a storage network interface, host bus adapter, or other interface capable of supporting communications with multiple host systems 112. Fabric network 114 may include a wired and/or wireless network (e.g., public and/or private computer networks in any number and/or configuration) which may be coupled in a suitable way for transferring data. For example, the fabric network may include any means of a conventional data communication network such as a local area network (LAN), a wide area network (WAN), a telephone network, such as the public switched telephone network (PSTN), an intranet, the internet, or any other suitable communication network or combination of communication networks. From the perspective of storage devices 120, storage interface bus 108 may be referred to as a host interface bus and provides a host data path between storage devices 120 and host systems 112, through storage controller 102 and/or an alternative interface to fabric network 114.

Host systems 112, or a respective host in a system having multiple hosts, may be any suitable computer device, such as a computer, a computer server, a laptop computer, a tablet device, a netbook, an internet kiosk, a personal digital assistant, a mobile phone, a smart phone, a gaming device, or any other computing device. Host systems 112 are sometimes called a host, client, or client system. In some embodiments, host systems 112 are server systems, such as a server system in a data center. In some embodiments, the one or more host systems 112 are one or more host devices distinct from a storage node housing the plurality of storage devices 120 and/or storage controller 102. In some embodiments, host systems 112 may include a plurality of host systems owned, operated, and/or hosting applications belonging to a plurality of entities and supporting one or more quality of service (QoS) standards for those entities and their applications. Host systems 112 may be configured to store and access data in the plurality of storage devices 120 in a multi-tenant configuration with shared storage resource pools, such as host connections to namespaces defined in storage devices 120.

Storage controller 102 may include one or more central processing units (CPUs) or processors 104 for executing compute operations, storage management operations, and/or instructions for accessing storage devices 120 through storage interface bus 108. In some embodiments, processors 104 may include a plurality of processor cores which may be assigned or allocated to parallel processing tasks and/or processing threads for different storage operations and/or host storage connections and operate alone or in combination. In some embodiments, processor 104 may be configured to execute fabric interface for communications through fabric network 114 and/or storage interface protocols for communication through storage interface bus 108 and/or control bus 110. In some embodiments, a separate network interface unit and/or storage interface unit (not shown) may provide the network interface protocol and/or storage interface protocol and related processor and memory resources.

Storage controller 102 may include a memory 106 configured to support a storage interface controller, such as NVMeoF controllers 106.1 and 106.2 that control communication between hosts 112 and storage devices 120 in accordance with a corresponding storage interface protocol. For example, NVMeoF controller 106.1 may support a plurality of namespaces allocated in storage devices 120 and manage access from hosts 112 through host connections to command queues allocated in storage devices 120. In some embodiments, memory 106 may include one or more dynamic random access memory (DRAM) devices for use by storage devices 120 for command, management parameter, and/or host data storage and transfer to support namespaces in those storage devices. In some embodiments, storage devices 120 may be configured for direct memory access (DMA), such as using remote direct memory access (RDMA) protocols, over storage interface bus 108.

In some configurations, NVMeoF controllers 106.1 and 106.2 may provide redundant interfaces for hosts 112 to access the shared storage resources of storage devices 120. For example, NVMeoF controllers 106.1 and 106.2 may be embodied in separate storage interface adapter circuits or cards that provide redundant network interfaces and one or more backend switches for connection to storage devices 120. In some configurations, NVMe-oF controllers 106.1 and 106.2 may support adaptive timeout notifications to hosts 112 based on enhanced KATO logic 150.1 and 150.2 and corresponding KATO tables 152.1 and 152.2 or similar timeout data structures. For example, KATO logic 150 may include selectively enabled logic configured for a set of different timeout conditions and corresponding system states that are mapped to timeout status codes. Upon the occurrence of a timeout condition based on loss of communication between a host and target namespace in storage devices 120, KATO logic 150 may determine the current system state and corresponding current timeout status code for the cause of the interruption in host communication. KATO logic 150 may use the current timeout status code to provide an asynchronous timeout notification with the status code to the impacted host(s) and enable the hosts to respond to the current timeout status code by modifying their retry pattern for an anticipated timeout value. In some configurations, KATO logic 150 may use KATO table 152 to manage timeout status codes and corresponding timeout values that adapt during the operation of storage system 100. For example, KATO table 152 may include a data structure comprised of status entries mapping each timeout status code to a default timeout value and a current or adapted timeout value. In some configurations, KATO table 152 may also be used to provide the timeout values corresponding to the various timeout status codes to the hosts. For example, each host may request, such as through a get-feature request, a copy of KATO table 152 and use the values in that table to determine the timeout value for the current timeout status code during a timeout condition.

In some embodiments, data storage system 100 may include a baseboard management controller (BMC) 160. BMC 160 may include a specialized service processor that monitors the physical state of a computer, network server or other hardware device using sensors and communicating with the system administrator through an independent connection. In data storage system 100, BMC 160 may provide valuable information about the status and health of data storage devices 120, including temperature, drive status, and other physical conditions that could affect the performance or availability of the storage. BMC 160 may include a processor 162 and a memory 164 that operate independently of the host system's CPU, firmware, and operating system, such as storage controller 102, allowing it to function even when the storage system is powered down or otherwise nonfunctional. Note that these processors and memories may comprise multiple processors and memories configured to operation alone or in combination as described for other system components herein. In addition to its functions for remote management and monitoring of storage systems from an administrative system, BMC 160 may support an additional communication channel through control bus 110 to storage devices 120 and other subcomponents of data storage system 100, including NVMeoF controllers 106.1 and 106.2. For example, BMC 160 and control bus 110 may support low bandwidth communication protocols, such as Inter-Integrated Circuit (I2C), Serial Peripheral Interface (SPI), Improved Inter-Integrated Circuit (I3C), System Management Bus (SMBus), Universal Asynchronous Receiver/Transmitter (UART), or similar control bus protocols. For example, I2C is a synchronous, multi-master, multi-slave, packet-switched, single-ended, serial communication bus and corresponding protocol that may allow NVMeoF controllers 106.1 and 106.2 to communicate directly to share reservation configurations and data and/or use communication with BMC 160 and memory 164 as an intermediary for data synchronization.

In some embodiments, data storage system 100 includes one or more processors, one or more types of memory, a display and/or other user interface components such as a keyboard, a touch screen display, a mouse, a track-pad, and/or any number of supplemental devices to add functionality. In some embodiments, data storage system 100 does not have a display and other user interface components.

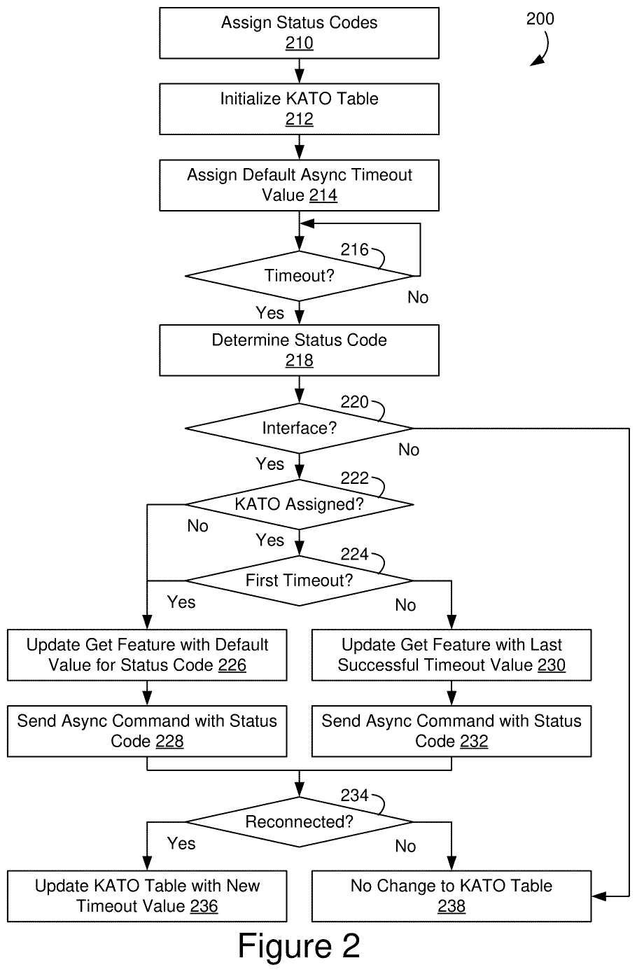

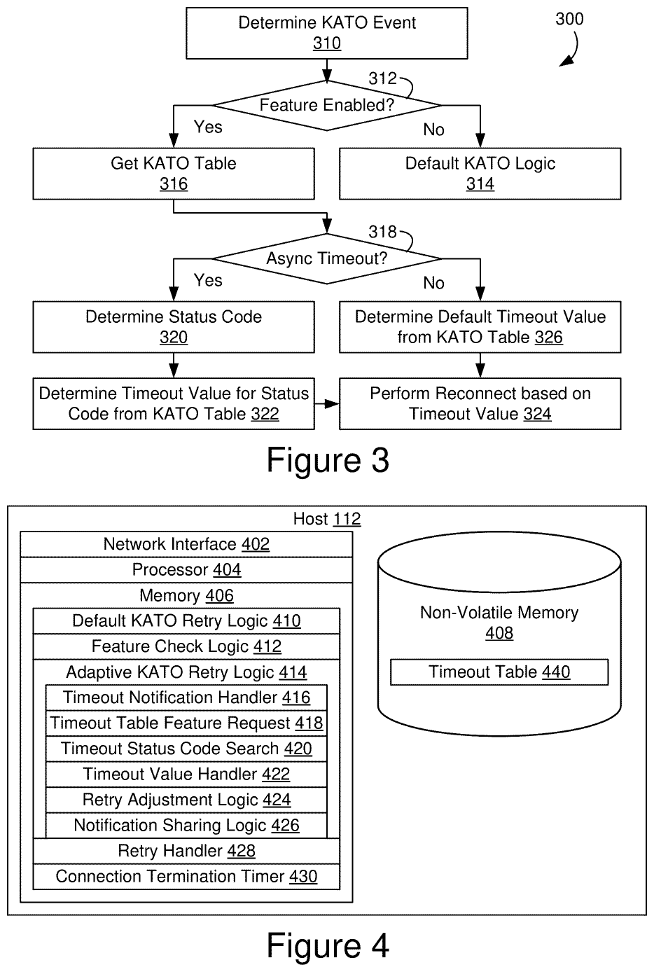

FIG. 2 illustrates a flowchart of a method 200 for managing KATO operations. Method 200 may be executed by storage controller 102 of storage system 100. Method 200 may determine and manage timeout status codes and corresponding timeout values for different system statuses. By executing method 200, storage controller 102 may provide adaptive timeout notifications to hosts 112 to adjust retry patterns for communication with the storage system 100.

At block 210, status codes may be assigned to different system statuses. For example, processor 104 of storage controller 102 may determine a set of timeout status codes corresponding to different system statuses such as data storage device replacement, data storage device hot plug transition, storage interface link down, host interface network malfunction, controller reset, and/or other possible system status reasons for timeout conditions.

At block 212, a KATO table may be initialized. For example, processor 104 may generate a data structure in memory 106 with entries mapping each timeout status code to a corresponding default timeout value.

At block 214, a default asynchronous (async) timeout value may be assigned. For example, processor 104 may set a default time period for sending asynchronous notifications to hosts 112 in the event of a timeout condition.

At decision block 216, a determination may be made whether a KATO timeout has occurred. For example, storage controller 102 may monitor communication through the fabric network 114, storage interface bus 108, and/or control bus 110 to detect any interruptions in host connections between the hosts 112 and storage devices 120 based on changed system states. If no timeout has occurred, storage controller 102 may continue to monitor for a timeout condition. If a timeout has occurred, storage controller 102 may continue to block 218.

At block 218, a status code may be determined. For example, if a timeout has occurred, processor 104 may analyze the current system status to identify the corresponding timeout status code from the set of assigned timeout status codes.

At decision block 220, a check may be performed to determine whether the host interface is available. For example, storage controller 102 may verify if a communication interface with the affected host 112 is still available for asynchronous administrative communication through the fabric network 114. If no host interface communication is available, storage controller 102 may proceed to block 236 and host 112 will use default KATO handling and retry patterns in the absence of communication from storage controller 102. If host interface communication is available, storage controller 102 may proceed to block 222.

At decision block 222, a verification may be made whether the status code has a KATO timeout value assigned. For example, processor 104 may check if a timeout value has been set for the status code in the KATO table. If no timeout value has been assigned, storage controller 102 may proceed to block 226. If a timeout value has been assigned, storage controller 102 may proceed to block 224.

At decision block 224, a determination may be made if this is a first timeout for the current timeout status code. For example, storage controller 102 may check if this is the initial timeout occurrence for the current host connection, status code, and operating period. If it is the first timeout, then storage controller 102 may proceed to block 226. If it is not the first timeout, then storage controller 102 may proceed to block 230.

At block 226, a get feature may be updated with a default value for the status code. For example, if this is a first timeout, processor 104 may set the timeout value in the KATO table to the default value for the current status code so that the table values may be provided to host 112 in response to a get feature command.

At block 228, an async command may be sent with the status code. For example, storage controller 102 may send an asynchronous notification to the affected host 112 through the fabric network 114, including the determined timeout status code.

At block 230, a get feature may be updated with the last successful reconnection timeout value. For example, if this is not a first timeout, processor 104 may set the timeout value in the KATO table to the most recent successful reconnection time for the current status code.

At block 232, an async command may be sent with the status code. For example, storage controller 102 may send an asynchronous notification to the affected host 112 through the fabric network 114, including the determined timeout status code.

At decision block 234, a check may be performed to determine if reconnection occurred. For example, storage controller 102 may monitor fabric network 114 and storage interface bus 108 to detect if the host connection has been reestablished after one or more retry attempts from host 112. If no reconnection bas been made, storage controller 102 may proceed to block 238 and continue to monitor for reconnection. If reconnection between host 112 and the target storage device 120 is established, storage controller 102 may proceed to block 236

At block 236, the KATO table may be updated with a new timeout value. For example, if reconnection occurred, processor 104 may modify the timeout value in the KATO table for the current status code based on the actual reconnection time.

At block 238, no change may be made to the KATO table. For example, if reconnection did not occur, the processor 104 may maintain the current timeout values in the KATO table until reconnection occurs or a default maximum timeout is reached and the connection is closed.

A method 300 for managing reconnection operations for KATO events may be implemented by host systems 112 in FIG. 1. Method 300 may enable an example host system 112 to adaptively handle KATO conditions based on status codes received from a storage controller 102. By executing the method 300, host system 112 may adjust retry patterns for communication with the storage system 100 to improve efficiency and reduce unnecessary network traffic.

At block 310, a KATO event may be determined. For example, the host system 112 may detect a loss of communication with a target namespace in a storage device 120 of the storage system 100.

At decision block 312, a determination may be made whether the adaptive KATO feature is enabled. For example, host system 112 may check if adaptive KATO handling is supported and activated for the current connection based on configuration parameters stored by host system 112. If the feature is not enabled, then host system 112 may proceed to block 314. If the feature is enabled, then host system 112 may proceed to block 316.

At block 314, default KATO logic may be executed. For example, if the adaptive KATO feature is not enabled, the host system 112 may revert to standard retry patterns with a fixed default timeout value that is independent of the cause of connection loss or system state, such as a regular period of retry attempts followed by connection termination at the default timeout value.

At block 316, a KATO table may be obtained. For example, if the adaptive KATO feature is enabled, host system 112 may use a get feature command to request and receive a copy of KATO table 152 from storage controller 102.

At decision block 318, a check may be performed to determine if an async timeout notification has been received. For example, host system 112 may monitor for receipt of an asynchronous notification from the storage controller 102 within a predefined time period. If an asynchronous notification is received, then host system 112 may proceed to block 320. If no asynchronous notification is received, then host system 112 may proceed to block 326.

At block 320, a status code may be determined. For example, if an async notification is received, host system 112 may extract the current timeout status code from the notification message.

At block 322, a timeout value for the status code may be determined from the KATO table. For example, host system 112 may look up the corresponding timeout value for the received status code in the local copy of the KATO table 152.

At block 324, reconnection based on retry attempts may be performed based on the timeout value. For example, if a timeout status code was received, host system 112 may adjust retry patterns and connection termination times based on the determined timeout value for the current status code, reducing or delaying the retries to target the most likely reconnection time for the particular system status.

At block 326, a default timeout value may be determined from the KATO table. For example, if no async notification is received, host system 112 may use a default timeout value from KATO table 152 for standard retry attempts. This default timeout value may be set as part of the adaptive KATO feature and different from the default timeout value that would be used if the adaptive KATO feature was not enabled. Host system 112 may proceed to block 324 to attempt retries to reconnect using a default pattern of retry attempts until the default timeout value is reached.

FIG. 4 shows components of example host system 112 configured for adaptive KATO handling in response to asynchronous timeout notifications. Host system 112 may include a network interface 402, a processor 404, memory 406, and non-volatile memory 408. These components may work together to enable the host system 112 to communicate with the storage system 100 and manage KATO conditions based on status codes and timeout values received from the storage controller 102.

Network interface 402 may enable communication with the fabric network 114 for connecting to the storage system 100. For example, network interface 402 may include any transceiver-like mechanism that enables host system 112 to communicate with other devices and/or systems, such as an RDMA network interface card (RNIC) or conventional Ethernet interface supporting transport control protocol (TCP) communication. Processor 404 may include one or more processors for executing instructions stored in the memory 406 to perform KATO handling operations and other host functions. For example, processor 404 may include one or more of any type of conventional processor or microprocessor that interprets and executes instructions, alone or in combination. Memory 406 may include local host memory for storing program instructions and runtime data for KATO handling. For example, memory 406 may include a random access memory (RAM) or another type of dynamic storage device that stores information and instructions for execution by processor 404, a read only memory (ROM) or another type of static storage device that stores static information and instructions for use by processor 404, and/or any suitable local storage element such as a hard disk or a solid state storage element. Non-volatile memory 408 may locally store persistent data for use by host system 112 and may include a hard drive or solid state storage accessible to host system 112 over a bus or peripheral interface connection. In some configurations, host system 112 may store a local copy of a timeout table 440 containing timeout values for various status codes in non-volatile memory 408. In some configurations, host system 112 may include one or more optional input and output components, not shown. An optional input unit may include one or more conventional mechanisms that permit an operator to input information to host system 112 such as a keyboard, a mouse, a pen, microphone and voice recognition, and/or biometric mechanisms, etc. Optional output units may include one or more conventional mechanisms that output information to the operator, such as a display, a printer, a speaker, etc.

Memory 406 may include several logical components for KATO handling that may be embodied in instructions for execution by processor 404. Default retry logic 410 may implement standard KATO retry patterns when adaptive features are not enabled. For example, default retry logic 410 may use a retry pattern defined by the network and/or storage application protocols, such as NVMe-oF, that defines a series of retry attempts at predetermined intervals (e.g., every 10 seconds) and default timeout value (e.g., 2 minutes) for terminating the connection if the retries fail to reconnect. In some configurations, default KATO retry logic 410 may include customizable configuration parameters that allow individual hosts to be configured with different default retry intervals and timeout values. Feature check logic 412 may determine if adaptive KATO handling is supported and activated for a given connection. For example, each time a connection request is sent to a target storage system that supports adaptive KATO, the request may include a parameter that specifies whether the adaptive KATO feature is enabled for that connection (e.g., “nvme connect-all-a<ip_address_of_target>-k custom”) and whether or not the feature is supported and/or enabled may be stored in connection metadata for the host connections. Adaptive KATO retry logic 414 may adjust retry patterns based on received status codes and timeout values and will be further described below. Retry handler 428 may manage the execution of retry attempts based on the default or adjusted retry patterns. For example, once the retry pattern for a given timeout condition is determined, retry handler 428 will time and generate the retry attempts, as well as monitor for responses indicating successful reconnection Termination timer 430 may control when to terminate connection attempts based on the timeout values and retry patterns. For example, timeout timer 430 may initialize a timer for the host connection when the timeout condition is first detected based on lack of response and track the elapsed time until the timeout value set by default KATO retry logic 410 or adaptive KATO retry logic 414. The timer may be stopped if reconnection occurs in response to a retry attempt and the elapsed time meeting or exceeding the set timeout value for the connection may initiate termination of that connection for expiration of its keep alive window.

Adaptive KATO retry logic 414 may include various features, modules, or logical subroutines for executing functions to support the adaptive KATO feature, when enabled. A timeout notification handler 416 may receive and process asynchronous timeout notifications received from storage controller 102. For example, host system 112 may be configured to receive asynchronous messages from storage controller 102 through administrative queues and corresponding messages and timeout notification messages may include a notification type parameter for the timeout notification type and one or more corresponding parameter values, such as a timeout status code value and/or updated timeout value for that status code. Timeout notification handler 416 may receive notification messages including the timeout notification type and parse them to determine the current timeout status code and/or updated timeout value. Timeout notification handler 416 may also determine when no timeout notification has been received within a notification monitoring period following identification of a timeout condition to determine whether default KATO retry logic 410 should be used. Timeout table feature request handler 418 may manage get feature requests for timeout table 440 and updates thereto. For example, during initialization, responsive to a timeout notification, and/or on a periodic basis, timeout table feature request handler 418 may generate and send a get feature request to storage controller 102 that returns the current values for timeout table 440 or a similar data structure. Status code searcher 420 may locate the appropriate timeout value for a given status code in the timeout table 440. For example, status code searcher 420 may use the current timeout status code as an index value for identifying a current timeout value for the status code entry from timeout table 440 that matches the current timeout status code value.

Timeout value handler 422 may extract and interpret timeout values from timeout table 440 and/or received in timeout notifications. For example, timeout value handler 422 may identify the timeout value to be applied to the timeout condition for the specific host connection and pass it to retry adjustment logic 424 for updating the retry pattern for the specific timeout value. In some configurations, timeout value handler 422 may use the status code and timeout value to determine whether there are other host connections in the same host that would be impacted by the timeout condition and system status and apply the timeout value to the retry handling for those connections as well. Retry adjustment logic 424 may modify retry patterns based on the determined timeout values. For example, default retry patterns may include predetermined retry interval and timeout value for connection termination. These retry patterns may be adjusted to better reflect the system state causing the timeout condition based on the determined timeout value and/or status code. In some configurations, the determined timeout value may replace the default timeout value for triggering connection termination. In some configurations, the retry interval may be increased to decrease the frequency of retry attempts and reduce administrative traffic, such as going from 10 second intervals to 30 second intervals. In some configurations, a retry window may be determined that limits the number of retry attempts to a window proximate the timeout value. For example, rather than making retry attempts from initial determination of the timeout condition until reconnection or connection termination, the start (or next) retry attempt after the status code may be based on a retry window with a delayed start, such as from 50 seconds after the start of the timeout condition until the timeout value, such as 90 seconds. These and other retry adjustments may be made individually or in any combination and may be represented in additional parameters associated with the timeout notification and/or in status entries in timeout table 440. Notification sharing logic 426 may enable host system 112 to share received status codes with neighboring host systems through broadcasts or other communication methods. For example, host system 112 may be configured in a shared domain with knowledge of other host systems connected to storage controller 102 and may use network communication among host systems to send a notification message identifying the target, timeout condition start time, and status code for the timeout condition. In some configurations, timeout value handler 422 may be configured to use target, time, and status code information received from other host systems to determine whether one or more host connections and/or timeout conditions for host system 112 are impacted and should have their retry patterns adjusted.

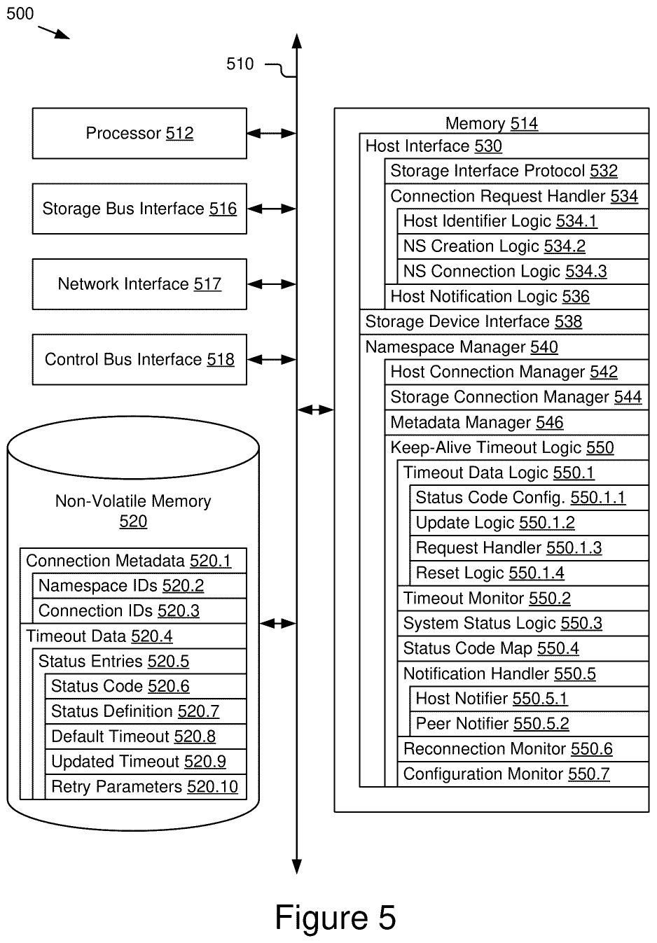

FIG. 5 schematically shows selected modules of a storage system 500 configured for managing adaptive KATO features in the storage interface controller. Storage system 500 may incorporate elements and configurations similar to those shown in FIGS. 1-2. For example, storage system 500 may be configured as NVMeoF controller 106.1 or 106.2 in FIG. 1. In some embodiments, storage system 500 may be embodied in a hardware NVMeoF controller, such as a specialized adapter circuit device that manages the communication between hosts and storage devices in an NVMeoF network. The NVMeoF controller may be responsible for receiving storage commands from hosts, directing these commands to the appropriate namespaces in the storage devices, and managing the responses. As described below, one or more NVMeoF controllers may be configured to provide adaptive timeout features and use timeout status codes and dynamic timeout values to allow host systems to better manage their retries during a timeout condition.

Storage system 500 may include a bus 510 interconnecting at least one processor 512, at least one memory 514, and at least one interface, such as storage bus interface 516, network interface 517, and/or control bus interface 518. Bus 510 may include one or more conductors that permit communication among the components of storage system 500. Processor 512 may include any number and type of processors or microprocessors that interpret and execute instructions or operations, alone or in combination. Memory 514 may include a random access memory (RAM) or another type of dynamic storage device that stores information and instructions for execution by processor 512 and/or a read only memory (ROM) or another type of static storage device that stores static information and instructions for use by processor 512 and/or any suitable storage element such as a hard disk or a solid state storage element. In some configurations, non-volatile memory devices 520 may include storage controller memory devices supporting memory 514 and/or allocated for system use in one or more of the attached SSDs. For example, non-volatile memory 520 may include onboard memory of one or more NVMeoF controllers used to store namespace metadata 520.1 and/or timeout data 520.4 in corresponding data structures, such as metadata or timeout data tables, databases, configuration pages, linked lists, memory arrays, etc.

Storage bus interface 516 may include a physical interface for connecting to one or more data storage devices, such as a peripheral component interconnect connecting to a corresponding switch, using an interface protocol that supports storage device access. For example, storage bus interface 516 may include a network (e.g., ethernet), PCIe, or similar storage interface connector supporting NVMe access to solid state media comprising non-volatile memory devices. These connected data storage devices may include one or more non-volatile memory devices or similar storage elements configured to store host data organized in namespaces or similar logical data containers. For example, non-volatile memory devices may include a plurality of flash memory packages organized as an addressable memory array.

Network interface 517 may be used by storage system 500 to communicate with a number of host systems. Network interface 517, also known as a host interface, may be a hardware component or a software module that provides a communication channel between storage system 500 and the host systems. Network interface 517 may support various network protocols, such as Ethernet, Fibre Channel, or InfiniBand, to facilitate the communication between storage system 500 and the host systems. The choice of network protocol can depend on various factors, such as the network infrastructure, the performance requirements, and the compatibility with the host systems, the storage devices, and NVMeoF protocols.

Control bus interface 518 may be used by storage system 500 to communicate with other hardware systems or subsystems, such as a baseboard management controller, and provide a communication path among subsystem components, such as multiple NVMe-F controllers. Control bus interface 518 may include a physical interface for connecting to a control bus using a low-bandwidth interface protocol for low-level control messaging among computing components. For example. control bus interface 518 may include a I2C, I3C, SPI, SMBus, UART, or similar bus interface connector supporting component-to-component messaging, such as multi-master, packet-based messaging over a two-wire bus.

Storage system 500 may include a plurality of modules or subsystems that are stored and/or instantiated in memory 514 for execution by processor 512 as instructions or operations. For example, memory 514 may include a host interface 530 configured to receive, process, and respond to host connection and data requests from client or host systems. Memory 514 may include a storage device interface 538 configured to establish backend connections with data storage devices hosting namespaces and processing host storage commands. Memory 514 may include a namespace manager 540 configured to manage host connections to namespaces through storage system 500, including the management of timeout conditions and related communication in response to temporary loss of communication between hosts and storage devices.

Host interface 530 may include an interface protocol and/or set of functions and parameters for receiving, parsing, responding to, and otherwise managing requests from host devices, nodes, or systems. For example, host interface 530 may include functions for receiving and processing host requests for establishing host connections with one or more namespaces for reading, writing, modifying, or otherwise manipulating client or host data in accordance with host communication and storage protocols. In some embodiments, host interface 530 may enable direct memory access and/or access over NVMe protocols, such as RDMA and transmission control protocol/internet protocol (TCP/IP) access, through storage bus interface 516 to host data units stored in the non-volatile memory devices of connected data storage devices. For example, host interface 530 may include host communication protocols compatible with ethernet and/or another host interface that supports use of NVMe and/or RDMA protocols for data access to host data.

In some embodiments, host interface 530 may include a plurality of hardware and/or software modules configured to use processor 512 and memory 514 to handle or manage defined operations of host interface 530. For example, host interface 530 may include a storage interface protocol 532 configured to comply with the physical, transport, and storage application protocols supported by the host for communication over network interface 517. For example, host interface 530 may include a connection request handler 534 configured to receive and respond to host connection requests. For example, host interface 530 may include a host notification logic configured to establish an administrative communication channel with the host system and enable asynchronous notifications to the host independent of host storage commands and responses. In some embodiments, host interface 530 may include additional modules (not shown) for command handling, buffer management, storage device management and reporting, and other host-side functions.

In some embodiments, storage interface protocol 532 may include network and/or PCIe and NVMe compliant communication, command, and syntax functions, procedures, and data structures. In some embodiments, storage interface protocol 532 may include an NVMeoF or similar protocol supporting RDMA, TCP/IP, and/or other connections for communication between host nodes and target host data in connected data storage devices, such as namespaces mapped to the particular host. Storage interface protocol 532 may include interface definitions for receiving host connection requests and storage commands from the fabric network, as well as for providing responses to those requests and commands. In some embodiments, storage interface protocol 532 may assure that host interface 530 is compliant with host request, command, and response syntax while storage device interface 538 may be configured to interface with the data storage devices for processing host storage commands. Storage interface protocol 532 may support host commands enabling adaptive KATO features and asynchronous notifications to the hosts.

In some embodiments, connection request handler 534 may include interfaces, functions, parameters, and/or data structures for receiving host connection requests in accordance with storage interface protocol 532, determining an available command queue, such as a queue-pair, allocating the host connection (and corresponding host connection identifier) to a storage device processing queue, and providing a response to the host, such as confirmation of the host storage connection or an error reporting that no processing queues are available. For example, connection request handler 534 may receive a storage connection request for a target namespace in a NVMeoF storage device and provide an appropriate namespace storage connection (through namespace manager 540) and host response. Connection request handler 534 may include host identifier logic 534.1 configured to use transport parameters from the host connection request to determine the host identifier of the request. Note that host identifiers may include host NVMe qualified names (NQNs) and are distinct from host connection identifiers, which identify a specific host connection to a namespace (and may support multiple connections from the same host to the same namespace). Namespace (NS) creation logic 534.2 may be initiated by connection request handler 534 in response to a host connection request for a namespace identifier that does not yet exist in the data storage devices. Namespace creation logic 543.2 may be configured to create a new namespace by allocating available storage space and a supported namespace from a data storage device to the new namespace identifier. For example, namespace creation logic 534.2 may initiate namespace manager 540 and storage device interface 538 to determine a target storage device and allocate the namespace in that storage device. Namespace (NS) connection logic 534.3 may be initiated by connection request handler 534 for an existing or newly created namespace to allocate a new host connection to that namespace for the requesting host. For example, namespace connection logic 534.3 may allocate a specific queue pair and host connection identifier to the combination of the host identifier and the namespace identifier. That connection may then be used for processing host storage commands to the namespace. In some embodiments, data describing each host connection request and/or resulting host connection may be stored by namespace manager 540, such as namespace identifiers 520.2 and host connection identifiers 520.3. In some configurations, host connection requests may include a parameter for enabling the adaptive KATO feature and NS connection logic 534.3 may parse the parameter value and store an indicator that adaptive KATO is enabled with connection identifier 520.3 in connection metadata 520.1.

In some embodiments, host notification logic 536 may include interfaces, functions, parameters, and/or data structures for providing asynchronous messages to the hosts, such as administrative and configuration related messages. For example, host interface 530 may support one or more administrative channels for providing notifications from storage system 500 to one or more host systems. Host notification logic 536 may support a variety of notification and other administrative messages to the host systems, including timeout notifications used for keep-alive timeout logic 550. For example, host notification logic 536 may receive a host notification call from KATO logic 550 that includes the connection identifier and/or other host identifiers and a set of parameters to include in the host notification, such as the current timeout status code, updated timeout value, and/or modified retry parameters. In the event that host communication through network interface 517 has been lost, host notification logic 536 may support alternative communication channels through peer notifications to other storage interface controllers and/or control bus communication.

Storage device interface 538 may include an interface protocol and/or set of functions, parameters, and data structures for communicating with connected data storage devices to establish host connections and enable command queue pairs (submission queues and completion queues) for processing host storage commands. Storage device interface 538 may be configured with a storage interface protocol similar to storage interface protocol 532 but supporting the backend connection between storage system 500 and the set of data storage devices it supports. For example, storage device interface 538 may receive host storage commands received by host interface 530 and direct them through one or more switches to the target data storage devices for processing. In some configurations, storage device interface 538 may also support administrative communication (such as via administrative queues and commands) for managing storage device and namespace configuration and other backend functions. For example, administrative commands may be used by system status logic 550.3 to evaluate backend storage connections and/or the status of individual data storage devices. In some configurations, one or more NVMeoF controllers and corresponding input/output modules of storage device interface 538 may be the only “hosts” connected to and visible from the storage devices and the storage devices may rely on storage device interface 538 for receiving all host storage commands and administrative commands.

Namespace manager 540 may include a set of functions, parameters, and data structures for managing namespaces and corresponding host connections in storage system 500. For example, namespace manager 540 may receive host connection requests and determine corresponding storage connections for each namespace, as well as managing namespace creation, deletion, connection and queue status, and timeout conditions across data storage devices. In some configurations, some or all functions of namespace manager 540 may be embodied in NVMeoF controller firmware operating as an intermediary between host interface 530 and storage device interface 538 and may use a control bus protocol for communication with other NVMeoF controllers in the same system through control bus interface 518. In some embodiments, namespace manager 540 may include a plurality of hardware and/or software modules configured to use processor 512 and memory 514 to handle or manage defined operations of namespace manager 540. For example, namespace manager 540 may include a host connection manager 542, a storage connection manager 544, a metadata manager 546, and KATO logic 550.

Host connection manager 542 and storage connection manager 544 may include interfaces, functions, parameters, and/or data structures configured to manage namespace allocations and connections between host systems and storage devices. For example, host connection manager 542 may include logic for receiving host connection requests and maintaining a list of host connection identifiers mapped to specific namespaces and queue pairs. Storage connection manager 544 may include logic for receiving the configurations of namespaces, command queues, and storage space available among storage devices and map new namespaces and host connections to the storage device resources. Host connection manager 542 and storage connection manager 544 may use metadata manager 546 and namespace metadata 520.1 to manage their respective front-end and back-end connections. Host connection manager 542 may be responsive to host interface 530 for processing host connection requests and delete requests, as well as managing host connection timeouts in cooperation with KATO logic 550. Storage connection manager 544 may be responsive to storage device interface 538 and manage storage device namespace and queue pair allocations for completing host connections.

Metadata manager 546 may include interfaces, functions, parameters, and/or data structures configured to manage namespace and corresponding connection data to assist in managing namespaces. For example, metadata manager 546 may receive data generated or received by host interface 530, storage device interface 538, and/or other components of namespace manager 540 and store it in one or more data structures in namespace metadata 520.1. In some configurations, metadata manager 546 may create, configure, and maintain a namespace metadata table or similar data structure for tracking sets of host connections to each namespace.

In some configurations, KATO logic 550 may be configured to support adaptive KATO using timeout status codes based on various system states and dynamically determine separate timeout values and/or other retry parameters to modify host reconnection attempts. For example, KATO logic 550 may maintain a set of status codes and corresponding timeout values that change as timeout conditions occur and are resolved within storage system 500. These status codes and their updated timeout values may be provided to the hosts and timeout notifications for specific timeout events may enable the host systems to use the current status code for the timeout condition and the corresponding timeout values to determine their retry pattern.

In some configurations, timeout data logic 550.1 may manage a timeout data structure, such as a KATO table, in timeout data 520.4 in non-volatile memory 520. For example, timeout data logic 550.1 may maintain a set of status entries 520.5, where each status entry corresponds to a unique status code 520.6 corresponding to a system state with a causal relationship to the timeout condition. In some configurations, each status entry may include a status code 520.6 and one or more other values selected from a status definition 520.7, a default timeout value 520.8, an updated timeout value 520.9, and one or more other retry parameters 520.10. Status definition 520.7 may include a text field with a description of the system status to assist host administrators in identifying the system status prompting the timeout condition. Default timeout value 520.9 may be a generically defined timeout value for all system states or a custom default timeout value calibrated for a maximum resolution time for that system state in a population of storage systems. Updated timeout value 520.9 may be a dynamically generated timeout value based on a prior occurrence of a timeout condition with the same status code during an operating period of storage system 500. Retry parameters 520.10 may include one or more change parameters in addition to the timeout value for modifying the default host retry patterns for a specific status code, such as a different retry interval or a retry delay value to define a reduced retry window proximate the updated timeout value. Timeout data logic 550.1 may be configured with a status code configuration 550.1.1 that defines the set of unique timeout status codes and their corresponding system states. For example, the set of status codes and corresponding system states may include: 0x0-data storage device replacement, 0x1-data storage device hot plug transition, 0x2-storage interface link down, 0x3-host interface network malfunction, and 0x4-controller reset. In some configurations, corresponding custom default values may also be included in status code configuration 550.1.1, such as a default timeout value in seconds for each status code. Update logic 550.1.2 may monitor or receive notification of reconnections that resolve timeout conditions and use the actual reconnection times to update the timeout value for that status code. For example, the first time a timeout condition for status code 0x0 is triggered the timeout value used will be the default timeout and, if the reconnection occurs in less than the default timeout (the connection was not terminated), the actual reconnection time will be reported to update logic 550.1.2 by reconnection monitor 550.6 and the updated timeout value may be added to the status entry for that status code. Request handler 550.1.3 may monitor or receive notification of host requests for updated timeout data, such as a current version of timeout data 520.4 and generate a response data structure that may be included the payload of a response to the request. For example, request handler 550.1.3 may be configured to receive notification of a get feature request received through host interface 530 and generate a KATO table or one or more entries therefrom to send to the host in response. Reset logic 550.1.4 may monitor or receive notification of reset conditions for returning timeout data 520.4 to its default data. For example, various conditions may be defined for changes in storage system 500 and/or the overall architecture, number of connected hosts, hardware or topology changes, etc. that may cause a significant change in reconnection patterns. Reset logic 550.1.4 may receive a notification from configuration monitor 550.7 or an explicit reset command through host interface 530 to delete all updated timeout values and return them to the default timeout values for those status codes. Initialization of storage system 500 and each occurrence of such a reset may define a new operating period for dynamically determining updated timeout values. Because timeout data 520.4 is stored in non-volatile memory 520, power cycling of the storage system, storage interface controller, and/or other components of the system may not trigger reset to default values and the timeout values learned in that operating period will persist.

Timeout monitor 550.2 may monitor or receive notification of timeout conditions triggered by the loss of communication between the host system and the data storage device for a particular host connection. For example, timeout monitor 550.2 may receive notification of failed storage commands from the host system that do not receive acknowledgement from the target data storage device. Communication failure may occur at or through network interface 317, within the storage controller (during controller reset or another interruption), at or through the storage bus interface 516 (including associated switches), or at the data storage devices (due to device failure resulting in replacement or hot plug transition). System status logic 550.3 may monitor or receive notification of the system state triggering a particular timeout event and corresponding timeout condition. For example, system status logic 550.3 may interface with one or more diagnostic subsystems of storage system 500 that monitor storage bus interface 516, network interface 517, and control bus interface 518 for state information related to the corresponding interfaces, links, and/or attached data storage devices to determine the system state that has caused the interruption in host communication through that particular host connection. Status code map 550.4 may be configured to map the system state data received by system status logic 550.3 to a corresponding timeout status code and return the current timeout status code for the system state and host connection.

Notification handler 550.5 may respond to the timeout condition and current status code to provide notification to one or more host systems. For example, notification handler 550.5 may initiate host notifier 550.5.1 to send a call including the current timeout status code to host notification logic 536 for initiating an asynchronous timeout notification to the host for that host connection. In some configurations, if communication through host interface 530 is not available due to the system state (network interface interruption), notification handler 550.5 may use peer notification 550.5.2 to attempt to send the notification through another storage interface controller. For example, some storage systems include multiple storage interface controllers in the same enclosure with independent network connections. Therefore, even if the controller that identifies the timeout condition does not have host communication through its network interface, the other controller may have host communication and the enclosure may include internal channels, such has communication over control bus interface 518 or storage bus interface 516 within the enclosure, that allow one controller to send a timeout notification through the peer channel for forwarding through the other controller's network interface. In such configurations, peer notifier 550.5.2 may be configured with a messaging interface for the peer channel and include logic for receiving and forwarding timeout notifications received through the peer channel.

Reconnection monitor 550.6 may monitor or receive notification of reconnection events that end the timeout condition. For example, reconnection monitor 550.6 may be notified when the system state is resolved and a host retry attempt is successful, restoring host communication for that host connection. Reconnection monitor 550.6 may also receive notification when the elapsed time of the timeout condition exceeds the timeout value and the connection is terminated. Configuration monitor 550.6 may monitor or receive notification of changes in configuration that may trigger a reset condition for reset logic 550.1.4. For example, configuration monitor 550.6 may receive host and storage device counts that represent the number of hosts and number of data storage devices currently connected to that controller and may include change thresholds for determining when the addition or removal of components corresponds to a configuration change that should trigger reset. Similarly, the number of host connections, namespaces, queue depths, and other operating factors may be used to monitor for changes in storage system configuration and trigger resets. In some configurations, changes in network configurations and overall system topology may provide a basis for initiating a reset. If these network or topology changes do not trigger change thresholds based on the connected systems or operating factors, then a system administrator or system administration tool may initiate an adaptive KATO feature reset command.

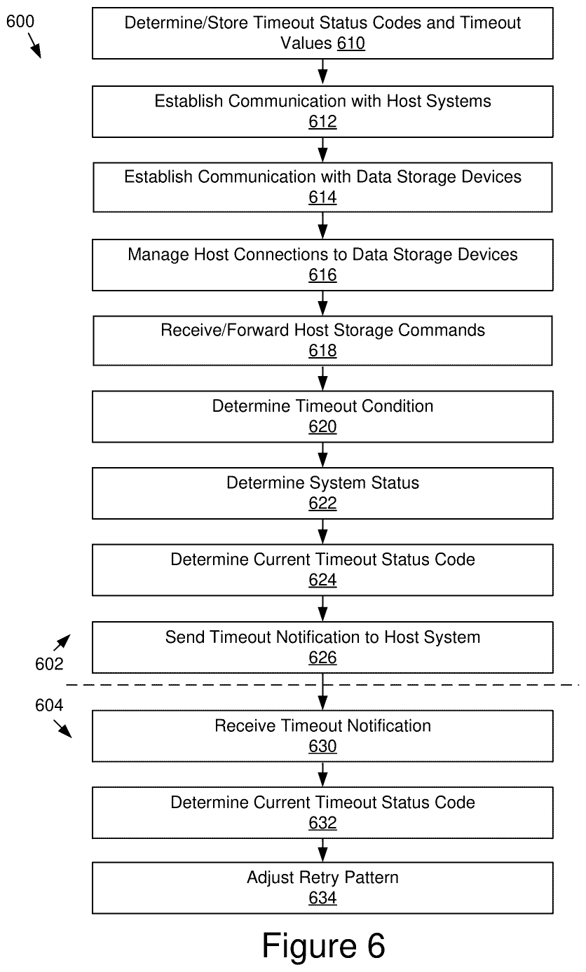

FIG. 6 illustrates a flowchart of a method 600 for managing timeout status codes and timeout values in a storage system. Method 600 may be executed by storage controller 102 of storage system 100 and/or storage system 500 and a corresponding host system 112. For example, a first portion 602 of method 600 may be executed by the storage controller and a second portion 604 may be executed by the host system receiving the timeout notification. Method 600 may determine and manage timeout status codes and corresponding timeout values for different system statuses. By executing method 600, the storage controller may provide adaptive timeout notifications to hosts to adjust retry patterns for communication with the storage system.

At block 610, timeout status codes and timeout values may be determined and stored. For example, processor 104 of storage controller 102 may determine a set of timeout status codes corresponding to different system statuses such as data storage device replacement, data storage device hot plug transition, storage interface link down, host interface network malfunction, controller reset, and/or other possible system status reasons for timeout conditions.

At block 612, communication may be established with host systems. For example, storage controller 102 may establish connections with one or more hosts 112 through the fabric network 114.

At block 614, communication may be established with data storage devices. For example, storage controller 102 may establish connections with one or more data storage devices through storage interface bus 108.

At block 616, host connections to data storage devices may be managed. For example, namespace manager 540 may establish and maintain host connections between hosts 112 and the plurality of data storage devices.

At block 618, host storage commands may be received and forwarded. For example, host interface 530 may receive host storage commands from hosts 112, and storage device interface 538 may direct those commands to target data storage devices based on the established host connections.

At block 620, a timeout condition may be determined. For example, timeout monitor 550.2 may detect a loss of communication between a host 112 and a target data storage device for a particular host connection.

At block 622, the system status may be determined. For example, system status logic 550.3 may analyze the current state of storage system 100 to identify the cause of the timeout condition.

At block 624, the current timeout status code may be determined. For example, status code map 550.4 may use the determined system status to identify the corresponding timeout status code from the set of assigned timeout status codes.

At block 626, a timeout notification may be sent to the host system. For example, notification handler 550.5 may send an asynchronous timeout notification including the current timeout status code to the affected host 112 through the host interface 530.

At block 630, a timeout notification may be received. For example, host 112 may receive the asynchronous timeout notification sent by storage controller 102 through network interface 402.

At block 632, the current timeout status code may be determined. For example, notification handler 416 of host 112 may extract the current timeout status code from the received timeout notification.

At block 634, the retry pattern may be adjusted based on the determined timeout status code and system conditions. For example, retry adjustment logic 424 of host 112 may modify the retry pattern for communication attempts based on the timeout value corresponding to the current timeout status code.

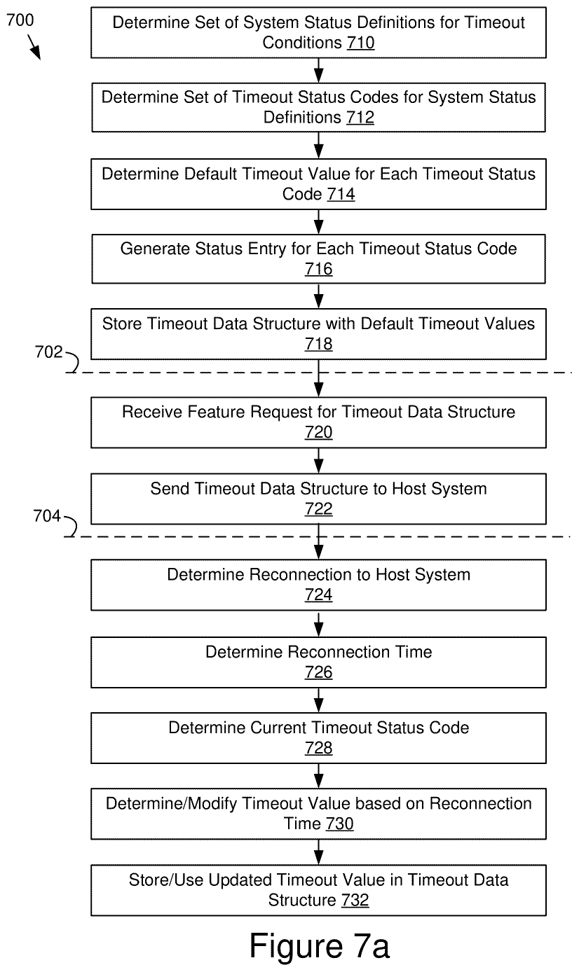

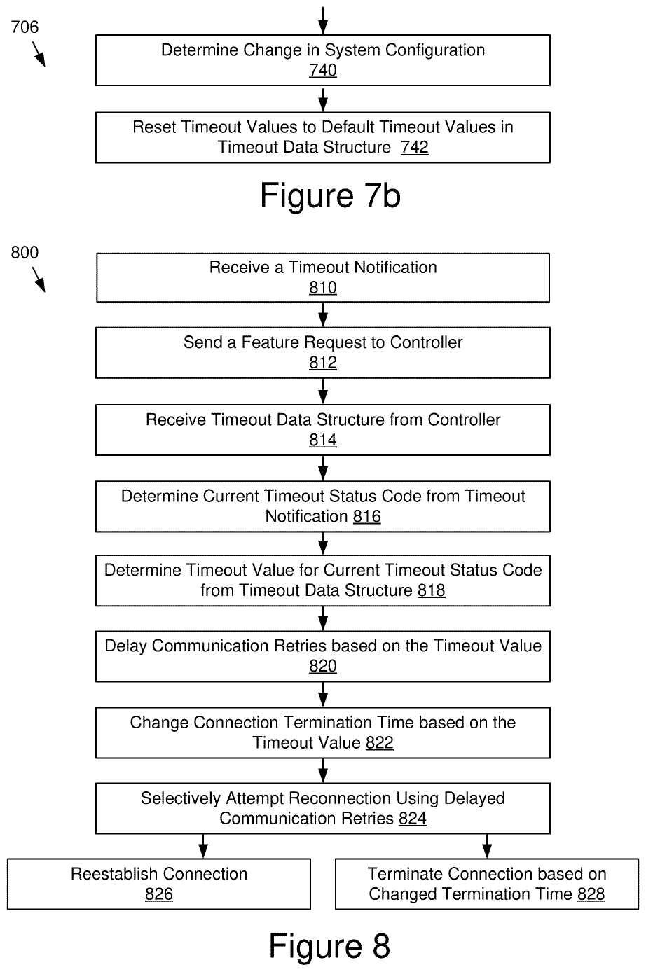

FIGS. 7a and 7b illustrate a flowchart of a method 700 for managing timeout data structures in a storage system. Method 700 may be executed by storage controller 102 of storage system 100 and/or storage system 500. Method 700 may determine and manage timeout status codes and corresponding adaptive timeout values for different system statuses. By executing method 700, storage controller 102 may provide adaptive timeout values to hosts 112 to adjust retry patterns for communication with storage system 100.

At block 710, a set of system status definitions for timeout conditions may be determined. For example, processor 104 of storage controller 102 may define a set of system statuses that can lead to timeout conditions, such as data storage device replacement, hot plug transitions, or network malfunctions.

At block 712, a set of timeout status codes for the system status definitions may be determined. For example, processor 104 may assign unique status codes to each of the defined system statuses, such as 0x0 for device replacement or 0x1 for hot plug transitions.

At block 714, default timeout values may be determined for each timeout status code. For example, processor 104 may assign initial timeout values to each status code based on expected resolution times for the corresponding system status.

At block 716, status entries may be generated for each timeout status code. For example, processor 104 may create entries in a timeout data structure, where each entry includes a status code, its corresponding system status definition, and the assigned default timeout value.

At block 718, the timeout data structure with default timeout values may be stored. For example, processor 104 may store the timeout data structure with the initial entries in the KATO table 152 of the storage controller 102.

At 702, the default timeout data structure may be ready for use in handling various timeout conditions for the storage system. In some configurations, method 700 may continue when a timeout condition occurs and a host responds to a timeout notification by requesting the timeout data structure.

At block 720, a feature request for the timeout data structure may be received. For example, storage controller 102 may receive a get-feature request from a host 112 through host interface 530.

At block 722, the timeout data structure may be sent to a host system. For example, storage controller 102 may send the current timeout data structure to the requesting host 112 through host interface 530 in response to the get-feature request.

At 704, the storage controller may handle one or more timeout conditions until one results in a reconnection event that triggers adaptation of the corresponding timeout value for the status code associated with the timeout condition. In some configurations, method 700 may continue when the timeout condition is resolved.

IAt block 724, reconnection to the host system may be determined. For example, reconnection monitor 550.6 may detect that communication with a host 112 has been reestablished after a timeout condition.

At block 726, a reconnection time may be determined. For example, the reconnection monitor 550.6 may calculate the elapsed time between the initial timeout condition and the successful reconnection.

At block 728, the current timeout status code may be determined. For example, update logic 550.1.2 may use the status code associated with the resolved timeout condition for determining whether and what updates should be made to the timeout value for that status code.

At block 730, the timeout value may be determined and modified based on the reconnection time. For example, update logic 550.1.2 may compare the actual reconnection time to the current timeout value for the status code and update it if necessary.

At block 732, the updated timeout value may be stored or used in the timeout data structure. For example, processor 104 may store the updated timeout value in the corresponding entry of the timeout data structure and that updated timeout value may be used for future timeout conditions having that that timeout status code.

In some configurations, method 700 may continue to portion 706 in FIG. 7b for responding to system configuration changes in a storage system. The storage controller may continue to use and update the timeout data structure for the adaptation of timeout values for various status codes throughout an operating period. This may continue until portion 706 is triggered by a system configuration change that meets one or more reset conditions for the timeout data structure.

At block 740, a change in system configuration may be determined. For example, configuration monitor 550.7 may detect changes in the number of connected hosts, storage devices, or other system components that may affect timeout behavior.

At block 742, timeout values may be reset to default timeout values in a timeout data structure. For example, reset logic 550.1.4 may restore all entries in the timeout data structure to their original default values in response to the detected configuration change. Reset of the timeout values may initiate a new operating period when the default timeout values will again adapt in response to various timeout conditions and reconnection events.

FIG. 8 depicts a method 800 for handling timeout notifications and reconnection attempts. Method 800 may be executed by a host system, such as one of the hosts 112 shown in FIGS. 1 and 4, in response to receiving a timeout notification from a storage controller. Method 800 may enable the host system to adaptively manage reconnection attempts based on timeout status codes and corresponding timeout values. By executing method 800, the host system may optimize its retry pattern and connection management strategy in response to various timeout conditions, reducing connection times and unnecessary administrative traffic.

At block 810, a timeout notification may be received. For example, the host system may receive an asynchronous timeout notification message from a storage controller through a network interface.

At block 812, a feature request may be sent to a controller. For example, the host system may generate and transmit a get-feature request to the storage controller to obtain the current timeout data structure.

At block 814, a timeout data structure may be received from the controller. For example, the host system may receive a response to the get-feature request containing the current timeout data structure with status codes and corresponding timeout values.

At block 816, a current timeout status code may be determined from the timeout notification. For example, the host system may extract the timeout status code from the received timeout notification message.

At block 818, a timeout value for the current timeout status code may be determined from the timeout data structure. For example, the host system may use the extracted timeout status code to look up the corresponding timeout value in the received timeout data structure.

At block 820, communication retries may be delayed based on the timeout value. For example, the host system may adjust its retry pattern by increasing the interval between retry attempts or delaying the start of retry attempts based on the determined timeout value.

At block 822, a connection termination time may be changed based on the timeout value. For example, the host system may reduce the connection termination time from a default connection termination time or maximum system timeout value to match the determined timeout value for the current status code.

At block 824, reconnection may be selectively attempted using delayed communication retries. For example, the host system may initiate communication retry attempts according to the adjusted retry pattern, which may include fewer attempts or attempts concentrated near the expected reconnection time.

At block 826, the connection may be reestablished. For example, the host system may successfully reconnect to the storage controller using one of the delayed retry attempts before the adjusted connection termination time is reached.

At block 828, the connection may be terminated based on the changed termination time. For example, if the host system fails to reconnect using the delayed retry attempts, it may close the connection when the adjusted termination time is reached.

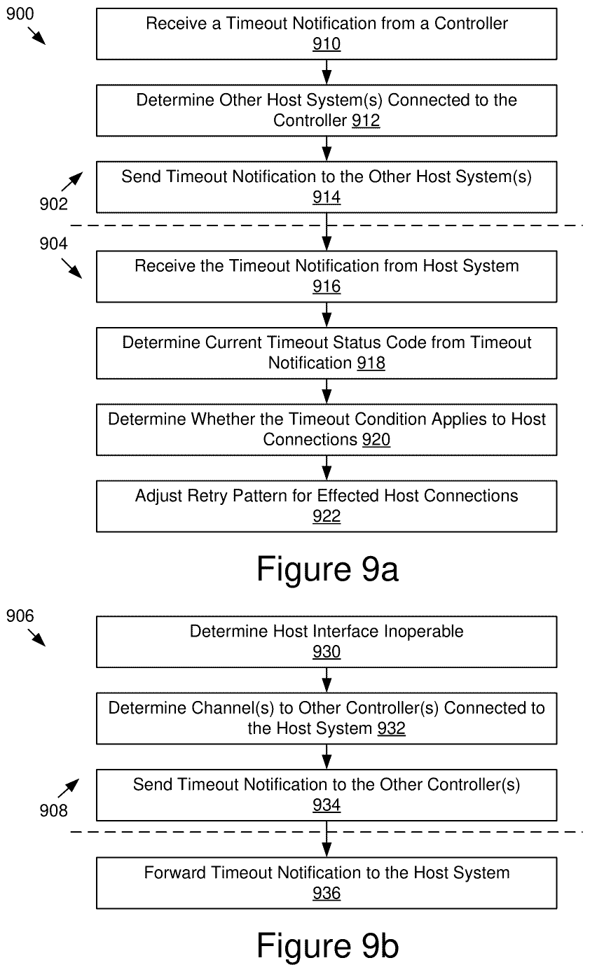

FIG. 9a illustrates a flowchart of a method 900 for handling timeout notifications in a storage system with host-to-host communication. Method 900 may be executed by a host system, such as one of the hosts 112 shown in FIGS. 1 and 4, in response to receiving a timeout notification from a storage controller or another host system. Method 900 may enable the host system to share timeout notifications with other connected host systems and adjust retry patterns accordingly, even if one or more systems have lost direct connection to the storage controller due to network or host interface errors. By executing method 900, the host system may propagate timeout information across multiple hosts, allowing for coordinated responses to timeout conditions in the storage system. In some configurations, portion 902 of method 900 may be executed by a first host system and portion 904 of method 900 may be executed by one or more other host systems.

At block 910, a timeout notification may be received from a controller. For example, a host system may receive an asynchronous timeout notification message from a storage controller through its network interface.

At block 912, other host system(s) connected to the controller may be determined. For example, the host system may consult its local configuration data or query the storage controller to identify other host systems that are currently connected to the same storage controller.

At block 914, the timeout notification may be sent to the other host system(s). For example, the host system may forward the received timeout notification to the identified host systems using a peer-to-peer communication protocol or through a shared messaging system.

At block 916, a timeout notification may be received from a host system. For example, a host system may receive a forwarded timeout notification from another host system in the storage network.

At block 918, the current timeout status code may be determined from the timeout notification. For example, the host system may extract and parse the timeout status code information from the received timeout notification message.

At block 920, a determination may be made as to whether the timeout condition applies to host connections for that host system. For example, the host system may analyze the timeout status code and compare it with its current active connections to the storage controller to determine if any of its connections are affected by the reported timeout condition.

At block 922, the retry pattern may be adjusted for affected host connections. For example, if the host system determines that one or more of its connections are affected by the timeout condition, it may modify its retry pattern for those connections based on the timeout status code and any associated timeout values.

FIG. 9b illustrates a flowchart of a method 906 for handling timeout notifications in a storage system when multiple storage controllers. Method 906 may be executed by two or more storage controllers, such as the storage controller 102 shown in FIG. 1, when it detects that its primary communication channel with a host system is unavailable. Method 906 may enable the storage controller to utilize alternative communication paths to deliver critical timeout notifications to affected host systems. By executing method 906, the storage controller may ensure that host systems receive important timeout information even when direct communication channels are compromised, allowing for continued adaptive management of connections in challenging network conditions. Portion 908 of method 906 may be executed by a first storage controller and block 936 may be executed by one or more other storage controllers with a peer-to-peer communication channel and host connections to the same host or hosts.

At block 930, a host interface may be determined to be inoperable. For example, the storage controller may detect a failure in its network interface that prevents direct communication with one or more connected host systems.

At block 932, channel(s) to other controller(s) connected to the host system may be determined. For example, the storage controller may identify alternative communication paths, such as through a second NVMeoF controller or through the control bus interface, that can be used to reach the affected host systems.

At block 934, the timeout notification may be sent to the other controller(s). For example, the storage controller may package the timeout notification with the relevant timeout status code and transmit it to one or more peer controllers using an internal communication protocol over the storage interface bus, control bus, or other peer communication channel.

At block 936, the timeout notification may be forwarded to the host system. For example, the receiving controller may process the timeout notification received from its peer and transmit it to the appropriate host system using its functional network interface, ensuring that the host receives the critical timeout information despite the original controller's communication failure.

While at least one exemplary embodiment has been presented in the foregoing detailed description of the technology, it should be appreciated that a vast number of variations may exist. It should also be appreciated that an exemplary embodiment or exemplary embodiments are examples, and are not intended to limit the scope, applicability, or configuration of the technology in any way. Rather, the foregoing detailed description will provide those skilled in the art with a convenient road map for implementing an exemplary embodiment of the technology, it being understood that various modifications may be made in a function and/or arrangement of elements described in an exemplary embodiment without departing from the scope of the technology, as set forth in the appended claims and their legal equivalents.

As will be appreciated by one of ordinary skill in the art, various aspects of the present technology may be embodied as a system, method, or computer program product. Accordingly, some aspects of the present technology may take the form of an entirely hardware embodiment, an entirely software embodiment (including firmware, resident software, micro-code, etc.), or a combination of hardware and software aspects that may all generally be referred to herein as a circuit, module, system, and/or network. Furthermore, various aspects of the present technology may take the form of a computer program product embodied in one or more computer-readable mediums including computer-readable program code embodied thereon.

Any combination of one or more computer-readable mediums may be utilized. A computer-readable medium may be a computer-readable signal medium or a physical computer-readable storage medium. A physical computer readable storage medium may be, for example, but not limited to, an electronic, magnetic, optical, crystal, polymer, electromagnetic, infrared, or semiconductor system, apparatus, or device, etc., or any suitable combination of the foregoing. Non-limiting examples of a physical computer-readable storage medium may include, but are not limited to, an electrical connection including one or more wires, a portable computer diskette, a hard disk, random access memory (RAM), read-only memory (ROM), an erasable programmable read-only memory (EPROM), an electrically erasable programmable read-only memory (EEPROM), a Flash memory, an optical fiber, a compact disk read-only memory (CD-ROM), an optical processor, a magnetic processor, etc., or any suitable combination of the foregoing. In the context of this document, a computer-readable storage medium may be any tangible medium that can contain or store a program or data for use by or in connection with an instruction execution system, apparatus, and/or device.

Computer code embodied on a computer-readable medium may be transmitted using any appropriate medium, including but not limited to, wireless, wired, optical fiber cable, radio frequency (RF), etc., or any suitable combination of the foregoing. Computer code for carrying out operations for aspects of the present technology may be written in any static language, such as the C programming language or other similar programming language. The computer code may execute entirely on a user's computing device, partly on a user's computing device, as a stand-alone software package, partly on a user's computing device and partly on a remote computing device, or entirely on the remote computing device or a server. In the latter scenario, a remote computing device may be connected to a user's computing device through any type of network, or communication system, including, but not limited to, a local area network (LAN) or a wide area network (WAN), Converged Network, or the connection may be made to an external computer (e.g., through the Internet using an Internet Service Provider).

Various aspects of the present technology may be described above with reference to flowchart illustrations and/or block diagrams of methods, apparatus, systems, and computer program products. It will be understood that each block of a flowchart illustration and/or a block diagram, and combinations of blocks in a flowchart illustration and/or block diagram, can be implemented by computer program instructions. These computer program instructions may be provided to a processing device (processor) of a general purpose computer, special purpose computer, or other programmable data processing apparatus to produce a machine, such that the instructions, which can execute via the processing device or other programmable data processing apparatus, create means for implementing the operations/acts specified in a flowchart and/or block(s) of a block diagram.

Some computer program instructions may also be stored in a computer-readable medium that can direct a computer, other programmable data processing apparatus, or other device(s) to operate in a particular manner, such that the instructions stored in a computer-readable medium to produce an article of manufacture including instructions that implement the operation/act specified in a flowchart and/or block(s) of a block diagram. Some computer program instructions may also be loaded onto a computing device, other programmable data processing apparatus, or other device(s) to cause a series of operational steps to be performed on the computing device, other programmable apparatus or other device(s) to produce a computer-implemented process such that the instructions executed by the computer or other programmable apparatus provide one or more processes for implementing the operation(s)/act(s) specified in a flowchart and/or block(s) of a block diagram.

A flowchart and/or block diagram in the above figures may illustrate an architecture, functionality, and/or operation of possible implementations of apparatus, systems, methods, and/or computer program products according to various aspects of the present technology. In this regard, a block in a flowchart or block diagram may represent a module, segment, or portion of code, which may comprise one or more executable instructions for implementing one or more specified logical functions. It should also be noted that, in some alternative aspects, some functions noted in a block may occur out of an order noted in the figures. For example, two blocks shown in succession may, in fact, be executed substantially concurrently, or blocks may at times be executed in a reverse order, depending upon the operations involved. It will also be noted that a block of a block diagram and/or flowchart illustration or a combination of blocks in a block diagram and/or flowchart illustration, can be implemented by special purpose hardware-based systems that may perform one or more specified operations or acts, or combinations of special purpose hardware and computer instructions.

While one or more aspects of the present technology have been illustrated and discussed in detail, one of ordinary skill in the art will appreciate that modifications and/or adaptations to the various aspects may be made without departing from the scope of the present technology, as set forth in the following claims.

1. A storage system, comprising:
a first storage interface controller comprising:
a host interface configured to receive host storage commands from at least one host system;
at least one memory; and
at least one processor configured to, alone or in combination:
determine, for each timeout status code of a plurality of timeout status codes, a corresponding default timeout value for that timeout status code, wherein each timeout status code corresponds to a different system status;
determine a timeout condition for communication from the at least one host system;
determine, for the timeout condition, a current timeout status code from the plurality of timeout status codes; and
send, to the at least one host system, a timeout notification comprising the current timeout status code, wherein the at least one host system is configured to adjust, responsive to the current timeout status code, a retry pattern for communication from the at least one host system to the first storage interface controller.

2. The storage system of claim 1, wherein the at least one processor is further configured to, alone or in combination:
determine, for the timeout condition, a reconnection time based on a restoration of communication from the at least one host system;
modify, based on the reconnection time, the default timeout value for the current timeout status code to an updated timeout value; and
use the updated timeout value for future timeout conditions having a same timeout status code as the current timeout status code.

3. The storage system of claim 1, wherein:
the first storage interface controller further comprises a timeout data structure comprising an entry for each timeout status code of the plurality of timeout status codes;
each entry comprises that timeout status code and a corresponding timeout value; and
the at least one processor is further configured to, alone or in combination, store, for each timeout status code and at a first time, the corresponding default timeout value as the corresponding timeout value.

4. The storage system of claim 3, wherein the at least one processor is further configured to, alone or in combination:
determine, responsive to a reconnection following a timeout condition for a timeout status code, an updated timeout value for that timeout status code; and
store, at a second time, the updated timeout value for that timeout status code in the corresponding entry for that timeout status code in the timeout data structure.

5. The storage system of claim 4, wherein the at least one processor is further configured to, alone or in combination:
determine, at a third time, a change in configuration of the storage system; and
reset, responsive to the change in configuration, the entries for the plurality of timeout status codes to the corresponding default timeout values.

6. The storage system of claim 3, wherein:
the at least one processor is further configured to, alone or in combination, send the timeout data structure to the at least one host system;
the at least one host system is further configured to, responsive to the current timeout status code in the timeout notification, determine the corresponding timeout value from the timeout data structure; and
the adjusted retry pattern is:
based on the corresponding timeout value;
delays at least one communication retry; and
changes a connection termination time for the retry pattern from a default connection termination time.

7. The storage system of claim 6, wherein:
the at least one host system is further configured to, responsive to receiving the timeout notification, send a feature request to the first storage interface controller; and
the at least one processor is further configured to, alone or in combination, send the timeout data structure to the at least one host system responsive to receiving the feature request.

8. The storage system of claim 1, wherein:
the at least one host system comprises a first host system and at least one other host system;
the first host system is configured to:
receive the timeout notification from the first storage interface controller; and
send, responsive to receiving the timeout notification, the timeout notification to the at least one other host system; and
the at least one other host system is configured to:
receive the timeout notification from the first host system;
determine, based on the current timeout status code, whether the timeout condition applies to at least one connection to the first storage interface controller from the at least one other host system; and
adjust, responsive to the timeout condition applying to the at least one connection to the first storage interface controller, a retry pattern for communication from the at least one other host system to the first storage interface controller.

9. The storage system of claim 1, further comprising:
a second storage interface controller comprising a second host interface configured to receive host storage commands from the at least one host system, wherein:
the at least one processor is further configured to, alone or in combination:
determine, based on the timeout condition, that the host interface to the at least one host system is inoperable; and
send the timeout notification to the second storage interface controller; and
the second storage interface controller is configured to forward the timeout notification to the at least one host system using the second host interface.

10. The storage system of claim 1, further comprising:
a data storage device enclosure comprising:
a plurality of data storage devices; and
the first storage interface controller, wherein:
the first storage interface controller further comprises a storage interface configured for communication with the plurality of data storage devices;
the at least one processor is further configured to, alone or in combination:
establish host connections between the at least on host system and the plurality of data storage devices; and
direct received host storage commands to target data storage devices from the plurality of data storage devices based on the host connections; and
the plurality of timeout status codes comprise timeout status codes corresponding to different system status selected from:
data storage device replacement;
data storage device hot plug transition;
storage interface link down;
host interface network malfunction; and
controller reset.

11. A computer-implemented method, comprising:
receiving, by a first storage interface controller, host storage commands from at least one host system;
determining, by the first storage interface controller and for each timeout status code of a plurality of timeout status codes, a corresponding default timeout value for that timeout status code, wherein each timeout status code corresponds to a different system status;
determining, by the first storage interface controller, a timeout condition for communication from the at least one host system;
determining, by the first storage interface controller and for the timeout condition, a current timeout status code from the plurality of timeout status codes;
sending, by the first storage interface controller and to the at least one host system, a timeout notification comprising the current timeout status code; and
adjusting, by the at least one host system and responsive to the current timeout status code in the timeout notification, a retry pattern for communication from the at least one host system to the first storage interface controller.

12. The computer-implemented method of claim 11, further comprising:
determining, by the first storage interface controller and for the timeout condition, a reconnection time based on a restoration of communication from the at least one host system;
modifying, by the first storage interface controller and based on the reconnection time, the default timeout value for the current timeout status code to an updated timeout value; and
using, by the first storage interface controller, the updated timeout value for future timeout conditions having a same timeout status code as the current timeout status code.

13. The computer-implemented method of claim 11, further comprising:
storing, by the first storage interface controller, a timeout data structure comprising an entry for each timeout status code of the plurality of timeout status codes, wherein:
each entry comprises that timeout status code and a corresponding timeout value; and
the corresponding timeout value, at a first time, is the corresponding default timeout value.

14. The computer-implemented method of claim 13, further comprising:
determining, by the first storage interface controller and responsive to a reconnection following a timeout condition for a timeout status code, an updated timeout value for that timeout status code; and
storing, by the first storage interface controller and at a second time, the updated timeout value for that timeout status code in the corresponding entry for that timeout status code in the timeout data structure.

15. The computer-implemented method of claim 14, further comprising:
determining, by the first storage interface controller and at a third time, a change in configuration of a storage system; and
resetting, by the first storage interface controller and responsive to the change in configuration, the entries for the plurality of timeout status codes to the corresponding default timeout values.

16. The computer-implemented method of claim 13, further comprising:
sending, by the first storage interface controller, the timeout data structure to the at least one host system;
determining, by the at least one host system and responsive to the current timeout status code in the timeout notification, the corresponding timeout value from the timeout data structure;
delaying, by the at least one host system and based on the corresponding timeout value, at least one communication retry in the retry pattern; and
changing, by the at least one host system and based on the corresponding timeout value, a connection termination time for the retry pattern from a default connection termination time.

17. The computer-implemented method of claim 16, further comprising:
sending, by the at least one host system and responsive to receiving the timeout notification, a feature request to the first storage interface controller; and
sending, by the first storage interface controller and responsive to the feature request, the timeout data structure to the at least one host system.

18. The computer-implemented method of claim 11, further comprising:
receiving, by a first host system of the at least one host system, the timeout notification from the first storage interface controller;
sending, by the first host system and responsive to receiving the timeout notification, the timeout notification to at least one other host system of the at least one host system;
receiving, by the at least one other host system, the timeout notification from the first host system;
determining, by the at least one other host system and based on the current timeout status code, whether the timeout condition applies to at least one connection to the first storage interface controller from the at least one other host system; and
adjusting, by the at least one other host system and responsive to the timeout condition applying to the at least one connection to the first storage interface controller, a retry pattern for communication from the at least one other host system to the first storage interface controller.

19. The computer-implemented method of claim 11, further comprising:
determining, by the first storage interface controller and based on the timeout condition, that a host interface to the at least one host system is inoperable;
sending, by the first storage interface controller, the timeout notification to a second storage interface controller comprising a second host interface configured to receive host storage commands from the at least one host system; and
forwarding, by the second storage interface controller, the timeout notification to the at least one host system using the second host interface.

20. A storage system comprising:
a plurality of data storage devices;
a host interface configured to receive host storage commands from a plurality of host systems;
a storage device interface configured to direct host storage commands to the plurality of data storage devices;
means for determining, for each timeout status code of a plurality of timeout status codes, a corresponding default timeout value for that timeout status code, wherein each timeout status code corresponds to a different system status;
means for determining a timeout condition for communication from at least one host system of the plurality of host systems;
means for determining, for the timeout condition, a current timeout status code from the plurality of timeout status codes; and
means for sending, to the at least one host system, a timeout notification comprising the current timeout status code, wherein the at least one host system is configured to adjust, responsive to the current timeout status code, a retry pattern for communication from the at least one host system to at least one data storage device of the plurality of data storage devices.
